(19) United States
(12) Patent Application Publication
(10) Pub. No.: US 2015/0293017 A1
(43) Pub. Date: Oct. 15, 2015

(54) PHOTOTHERMAL RESONANCE

(71) Applicant: DANMARKS TEKNISKE UNIVERSITET, Lyngby (DK)

(72) Inventors: Shoko Yamada, Vintrie (SE); Silvan Schmid, Copenhagen O (DK); Anja Boisen, Birkerod (DK); Tom Larsen, Aalborg (DK)

(21) Appl. No.: 14/438,094

(22) PCT Filed: Oct. 25, 2013
(86) PCT No.: PCT/DK2013/050343

§ 371 Date: Apr. 23, 2015

(30) Foreign Application Priority Data
Oct. 26, 2012 (EP) 12190200.1

(51) Int. Cl. G01N 21/39; G01N 29/24; G01N 21/17

(52) U.S. Cl. CPC G01N 21/39; G01N 21/1702; G01N 29/2418; G01N 2201/06113; G01N 2291/014

(57) ABSTRACT

The present invention relates to a method for detecting photo-thermal absorbance of a material utilising a mechanically temperature sensitive resonator (20) and a sample being arrange in thermal communication with the temperature sensitive resonator. The present invention further relates to an apparatus for detecting photo-thermal absorbance of a sample.

### FIELD OF THE INVENTION

The present invention relates to a method and apparatus for performing photo thermal mechanical resonance absorbance spectroscopy utilising shift in resonance frequency.

### BACKGROUND OF THE INVENTION

From U.S. Pat. No. 5,923,421 a chemical detector is known. The detector comprises: an array of sensing elements, each having a characteristic physical parameter and a coating exhibiting a preferential adsorption of a chemical to be sensed.

Further DE 38 18 888 discloses a method and a device specified for the detection of radiation absorptions of a substance by means of the detection of absorption-conditioned temperature changes of the substance.

When monitoring for particles or compounds there is always a need for an improved method and system.

Hence, an improved system for determining a characteristic of a material would be advantageous, and in particular a more efficient and/or reliable method for enabling determination of a compound or particle type would be advantageous.

It is a further object of the present invention to provide an alternative to the prior art.

### SUMMARY OF THE INVENTION

Micro and nano-electromechanical resonators have offered a range of highly sensitive mass sensors, but obtaining good specificity is generally challenging. Such gravimetric sensors lack intrinsic selectivity and typically rely on selective interfaces for chemical specificity. Spectroscopy techniques offer a simple and sensitive way to chemically analyze a sample and are therefore widely used in science and industry. The chemical information is obtained by measuring a unique interaction of the sample matter with a defined emitted energy. Detection of the unique spectrum of an analyte by infrared (IR) absorption spectroscopy can be a solution to the specificity problem when performing chemical analysis of increasingly smaller sample volumes.

In absorption spectroscopy, the energy absorbed by the sample is usually directly determined by measuring the fraction of light being transmitted through the sample. IR spectroscopy in the mid-infrared region provides information on molecular vibrations that result in a sample specific absorption spectrum, the so-called fingerprint. A minimum sample mass of 0.25 mg and additional 100 mg potassium bromide (KBr) are typically needed for preparing a micro-pellet for transmission measurements with Fourier transform IR spectroscopy (FTIR). It has been shown that femtogram-level paraffin can be sampled on an AFM microprobe and subsequently be analyzed with an FTIR microspectrometer. Another way is to determine the absorbed energy indirectly by measuring the absorption related heating of the sample. This so called photothermal spectroscopy is sensitive enough to study optically thin samples. It has been shown that photothermal absorption spectroscopy can be implemented as a mechanical sensor. By measuring the bending of a bi-layer cantilever (metal layer on silicon or silicon nitride cantilever) due to photothermal heating, the sensitivity was increased by two orders of magnitude compared to standard photothermal deflection spectroscopy. The cantilever-based photothermal spectroscopy has been applied for detecting chemicals, biomolecules, trace explosives and chemical warfare agents and for investigating polymer thin films. However, the cantilever deflection is directly subjected to thermomechanical noise and external vibrations.

Thus, the above described object and several other objects are intended to be obtained in a first aspect of the invention by providing a method for detecting photo-thermal absorbance of a material utilising a micro- or nanostring mechanically temperature sensitive resonator and a sample being arrange in thermal communication with the temperature sensitive resonator, the sample having a wavelength dependent absorption rate. The method may comprise the step of irradiating the sample at a pre-selected wavelength. The method may comprise the step of the sample absorbing the radiation at a certain wavelength or wavelengths resulting in a temperature increase of the sample and the temperature sensitive resonator, which in turn changes a resonance frequency of the temperature sensitive resonator. As the sample is in thermal communication with the temperature sensitive resonator heat is dissipated, or transported in other ways, to the temperature sensitive resonator. The method may comprise the step detecting photo-thermal absorbance by a change in resonance frequency of the temperature sensitive resonator. This may for instance be achieved by an apparatus determining vibrations in the resonance frequency of the temperature sensitive resonator without physical contact with the temperature sensitive resonator. The method may comprise the step of said detecting of change in resonance frequency being based on a detection of the resonance frequency of the temperature sensitive resonator prior to irradiation of the sample and a detection of the resonance frequency of the temperature sensitive resonator during and/or after the irradiation of the sample. The method thus relates to a photothermal IR spectroscopy technique, where mechanical string resonators are used as thermal sensors by monitoring the temperature induced frequency detuning. Generally strings allow for a simple fabrication (a single material clamped at both ends), a robust detection scheme (measuring frequency detuning), a minimum heat dissipation (no metals required & large aspect ratio). Finally strings facilitate simple non-diffusion limited analyte sampling.

By determining the change in resonant frequency of the combined resonator and sample it is possible to determine what type of compound or material is being examined. When a material is deposited on a resonator and the material is heated the heat dissipates to the temperature sensitive resonator; and thus the resonant frequency of the combined changes. This change gives an indication of which material is deposited. If a change in resonant frequency is present, this change occurs as a result of the temperature increase of the temperature sensitive resonator. The resonator may be a beam, a membrane or a string or have any other geometrical suitable form.

The irradiation of the sample should be performed at a high enough intensity as necessary but it's a balance between the intensity of irradiation, sensitivity of resonator and measurement stability. In an experimental setup a source was used with an nW level. Duration of irradiation should be long enough to allow the measurement to be performed with a sufficient sensitivity. In the experimental setup 1 sec was used.

The material used for the resonator may be selected so as to have an absorption pattern different from that material that is being monitored for. It is possible to use a material for the resonator which does not have substantial absorption within that of the material that are being monitored or search for. However these considerations would be taken into account when identifying samples in general, i.e. without prior knowledge about the material being examined/tested via the method.

The method may include a step of recording data in a data storage regarding resonance frequency of the temperature sensitive resonator and time stamps, or other timing information, for when the resonance frequency of the temperature sensitive resonator was recorded. This would allow e.g. a calculation device to perform the necessary steps with due care of timing. As the sample may be deposited over time, more than one measurement may be needed.

Advantageously the step of irradiating the sample may comprise irradiating the sample while changing the pre-selected wavelength according to a pre-selected scheme. When looking for a specific compound it may be sufficient to investigate a single frequency to identify a peak. When looking more generally there may be a need for investigating the frequency to identify peaks or changes in resonant frequency over a broader range or a range of intervals or specific frequencies.

The responsivity of chemical or biochemical sensors is strongly dependent on the sample collection efficiency. The probability of nano-scale sample entities to stick to a micro- or nano-scale sensor surface by diffusion is very low, which results in long sampling times. For many other sensor applications, the available sample concentration is however below the detection limit. This problem is commonly overcome by performing a pre-concentration of the analyte. Sample preparation and pre-concentration are not only time consuming but also contributes about 30% to the error in the total analysis of a sample.

The present method includes using a photothermal sensor when applying an efficient non-diffusion limited sampling method in which airborne species may be directly collected on the mechanical string resonator with an up to 100% collection efficiency of the species that are flowing in the projection of the string resonator.

Advantageously the pre-selected scheme may include sweeping the wavelength, e.g. by sweeping the frequency, over a wavelength or frequency interval. The identification of the resonant frequency may be performed by sweeping the frequency of a test signal over an interval. In some embodiments more than one interval may be swept.

Advantageously the method may comprise applying a vibration at a predefined frequency to the temperature sensitive resonator. In general temperature should not be so high that the sample would evaporate, i.e. above the sample's evaporation temperature, and the temperature should not be too low or too high so that the resonator loses its tensile stress. It is in the general case not necessary to maintain a constant temperature around the resonator.

Advantageously the length of the resonator is in the interval 100 nm to 10 mm, such as in the interval of 1 um to 10 mm, such as to 150 to 300 um, such as 213 um, and/or the thickness of the resonator is in the interval 1 nm to 100 um, such as 185 nm, and/or wherein the width of the resonator is in the interval 1 nm to 1 mm, such as 1.2 um. The size of the resonator is preferably suited for detecting small amounts of material.

Advantageously the method may comprise an initial step of depositing an amount of material on the sample. The amount of material in the sample may be as low as, or even lower than, 1 ng. The system used in connection with the method may initially be supplied in a clean state and used in a setting where it looks for specific compounds. The system, and method, may be used periodically or according to a specific schedule or in response to a control system. The system and method may then be applied for detecting the presence of one or more compounds or particle.

By placing the sample in e.g. a stream of gas or liquid it is possible to detect the presence of a specific compound or particle type or simply determine which compound that has been deposited on the sample.

Advantageously the step of detecting change in resonance frequency of the resonator is performed using a vibrometer, any other suitable device based on optical or electrical determination of the resonance frequency of the resonator may be used. Using a non-contact device for determining resonant frequency has advantages such as less risk of contamination and increased sensitivity. Using an optical system for Doppler-shift measurements is an efficient way of determining resonant frequencies or resonant frequency of the resonator.

Advantageously the method may comprise determining a characteristic of the sample by the detection of the shift in resonance frequency. It may be advantageous to determine a specific characteristic of the sample, e.g. a specific binding in the molecules, whereby the material may be determined, or identification of a group whereto the material in the sample belongs.

Advantageously the change in resonant frequency is more than 1% of the initial resonance frequency. The required level of change in order to detect the change may be determined by the resolution of the apparatus used for determining the resonant frequency, e.g. the vibrometer mentioned above.

Advantageously the method may further comprise providing a temperature regulator and the method comprises maintaining a constant temperature. Constant temperature in the present context may be an interval around a target temperature. The ambient temperature has an influence on the temperature sensitive resonator. By maintaining a stable, known, temperature a more precise measurement is possible.

A second aspect of the present invention relates to an apparatus for detecting photo-thermal absorbance of a sample. The apparatus may comprise a mechanical temperature sensible resonator having a sample-area to receive a sample. The apparatus may comprise a light source for irradiating light at a pre-selected wavelength at least onto the sample-area of the resonator. The light source may be an irradiation source irradiating radiation at frequencies other than visible light. When in use, in case a sample is present at the sample-area the sample absorbs an amount of the irradiated light. The apparatus may comprise a photo-thermal absorbance detection device arranged for determining resonance frequency of the mechanical temperature sensible resonator. The apparatus may comprise a material determination device in communication with the photo-thermal absorbance detection device being configured for determining a change in resonant frequency of the mechanical temperature sensible resonator after a deposition of a sample on the sample-area, the determination of change in resonance frequency is based on a detection of the resonance frequency of the resonator prior to heating and a detection of the resonance frequency of the resonator during and/or after the heating. The material determination device may be in communication with or include a data base comprising data relating to resonant frequency information regarding one or more compounds or particles. The material determination device may include a screen device for displaying detected resonant frequency so as to allow an operator to inspect the information and thereby determine which compound or particle type is present on the test area.

The apparatus may be used for performing the method according to the first aspect. The apparatus may have a size that makes it suitable for monitoring e.g. air quality, monitor for compounds in liquids or the like. The apparatus may be placed in communication with e.g. a stream of liquid or gas. Advantageously a resonator device may be connected to the mechanical temperature sensible resonator so as to induce a vibration in the mechanical temperature sensible resonator. By applying a vibration to the mechanical temperature sensible resonator a more precise determination of the resonant frequency may be obtained.

Advantageously the apparatus may comprise a temperature regulating device for maintaining a constant ambient temperature at the mechanical temperature sensible resonator. As mentioned above a stable ambient temperature may increase the reliability of the measurements.

Advantageously the apparatus may comprise a temperature sensor for determining ambient temperature at the mechanical temperature sensible resonator.

Advantageously the photo-thermal absorbance detection device may be a vibrometer. Any other suitable device utilising optical or electrical means for determining resonant frequency may be used.

Advantageously the temperature sensitive resonator vibrates as a result of ambient temperature. In one embodiment no heat is added or removed so as to maintain the temperature within a specific temperature range. The range may e.g. be less than 1 degree.

The invention is particularly, but not exclusively, advantageous for obtaining a reliable detection of a specific chemical compound or a range of compounds.

In a third aspect, the invention relates to a computer program product being adapted to enable a computer system comprising at least one computer having data storage means in connection therewith to control an apparatus according to the second aspect of the invention. The computer program product may be an implementation of the method according to the first aspect.

This aspect of the invention is particularly, but not exclusively, advantageous in that the present invention may be accomplished by a computer program product enabling a computer system to carry out the operations of the apparatus/system of the second aspect of the invention when down- or uploaded into the computer system. Such a computer program product may be provided on any kind of computer readable medium, or through a network.

The individual aspects of the present invention may each be combined with any of the other aspects. These and other aspects of the invention will be apparent from the following description with reference to the described embodiments.

### BRIEF DESCRIPTION OF THE FIGURES

The above aspects according to the invention will now be described in more detail with regard to the accompanying figures. The figures show one way of implementing the present invention and is not to be construed as being limiting to other possible embodiments falling within the scope of the attached claim set.

FIG. 1 is a schematic illustration of a system,

FIG. 2 is in image of NaHCO3 coating on a SiN string,

FIG. 3 is a photothermal resonance spectrum of a silicon nitride string,

FIG. 4 is a photothermal resonance spectrum of NaHCO3 on silicon nitride string,

FIG. 5 is a potothermal resonance spectrum of CaCO3 on silicon nitride string,

FIG. 6 is a SEM micrograph of a silicon nitride string, and

FIG. 7 is a schematic illustration of steps of a method.

### DETAILED DESCRIPTION OF AN EMBODIMENT

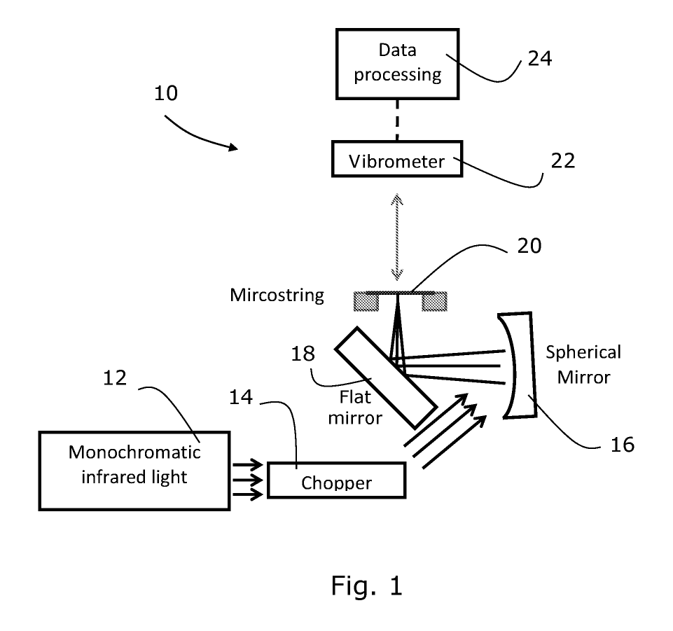

The photothermal resonance spectroscopy for airborne nanoparticles may be investigated by means of low stress silicon-rich silicon nitride as shown in FIG. 1.

FIG. 1 schematically illustrates a system 10 having a light source 12. The light source is here a monochromatic infrared light source. The light from the light source 12 is passed through a chopper 14. The chopper 14 chops the light signal at 1 Hz. In this embodiment the light source 12 sweeps the wavelength between 2.5 and 14.5 micrometer.

From the chopper 14 the light signal travels via a spherical mirror 16 and a flat mirror 18 so as to be focused on a microstring 20. Resonant micro and nano strings are of interest for sensor applications due to their extraordinary high quality factors and low mass. In the present specification the terms string and microstring are used interchangeably.

The microstring 20 is made from silicon nitride strings that have a thickness of 185 nm. The microstring 20 may in some embodiments have a width and length that vary between 1.2 and 5.3 um and 112 and 511 um, respectively. The fabrication of the strings is done by standard micromachining techniques as described e.g. in http://en.wikipedia.org/wiki/Microelectromechanical_systems and uses standard micromachining techniques

The spectrometer, i.e. the light source 12, has the capability of varying the wavelength from 2.5 to 14.5 um by using an interference filter wheel.

A vibrometer 22 is used to determine resonant frequency of the microstring 20. A laser Doppler vibrometer (LDV) is an instrument that is used to make non-contact vibration measurements of a surface. A laser beam from the LDV is directed at the surface of interest, and the vibration amplitude and frequency are extracted from the Doppler shift of the laser beam frequency due to the motion of the surface. The output of an LDV is generally a continuous analog voltage that is directly proportional to the target velocity component along the direction of the laser beam.

A vibrometer is generally a two beam laser interferometer that measures the frequency (or phase) difference between an internal reference beam and a test beam. The most common type of laser in an LDV is the helium-neon laser, although laser diodes, fiber lasers, and Nd:YAG lasers are also used. The test beam is directed to the target, and scattered light from the target is collected and interfered with the reference beam on a photodetector, typically a photodiode. Most commercial vibrometers work in a heterodyne regime by adding a known frequency shift (typically 30-40 MHz) to one of the beams. This frequency shift is usually generated by a Bragg cell, or acousto-optic modulator.

The output of the vibrometer 22 is passed to a data processing device 24. The data processing device 24 examines the spectrum to identify the material examined. This allow for detection of depositions of certain materials. The system and corresponding method may be used for detection of specific compounds. This could be useful for detecting the presence of nanoparticles in e.g. air. Such an example could be air quality at specific settings, such as airports or other areas where exhaust from engines are abundant. In an alternative embodiment the automatic examination of the spectrum to identify the material may be replaced or complemented by a person examining the spectrum.

The data processing device 24 may include or be connected to a data base comprising information relating to one or more absorption spectra for compounds and/or materials so any material deposited on the microstring 20 may be identified.

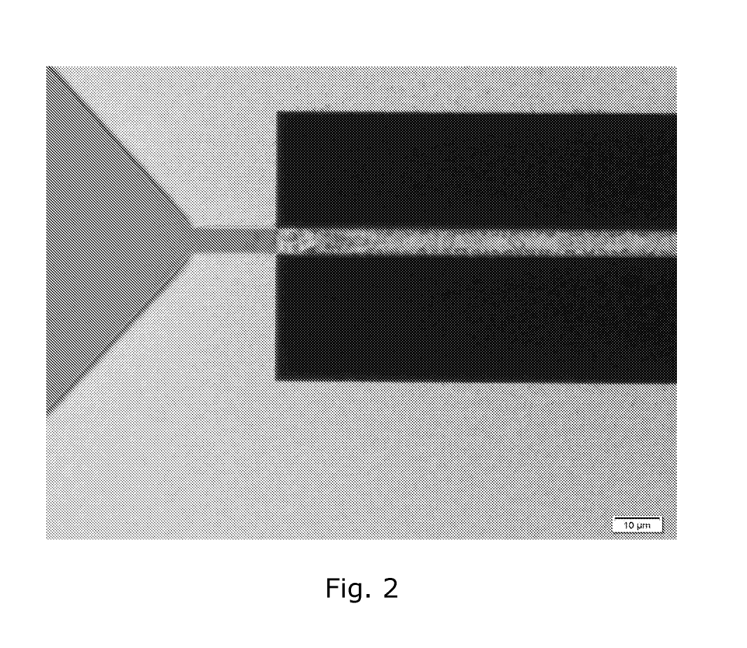

In a test setup a 0.018 wt % NaHCO3 solution and 0.05 wt % CaCO3 solution were prepared. The nanoparticles were produced by an atomizer (Model 9302 from TSI Inc.) and the diameters of NaHCO3 and CaCO3 nanoparticles were approximately 40 nm and 20 nm, respectively. The nanoparticles were deposited on the backside of the three strings comprised in the chip used in the set-up. FIG. 2 shows an optical micrograph of the coating for NaHCO3 nanoparticles.

Photothermal spectra of the nanoparticles on the string were in a test setup obtained by illuminating the string with monochromatic infrared radiation. The IR source and the interference filter wheel of a Foxboro Miran 1A-CVF spectrometer were used for the test setup.

The IR source, i.e. comparable to the light source 12, was used for illuminating the string as shown in the test setup. The resonant frequency of the string was determined optically with a laser-Doppler vibrometer (MSA-500 from Polytec GmbH) by measuring the thermal noise resonance peaks of the first bending mode. The string was placed in high vacuum at a pressure below 3*10-5 mbar and actuated by piezoelectric actuation at the peak resonance of the string in order to have higher resonating amplitude.

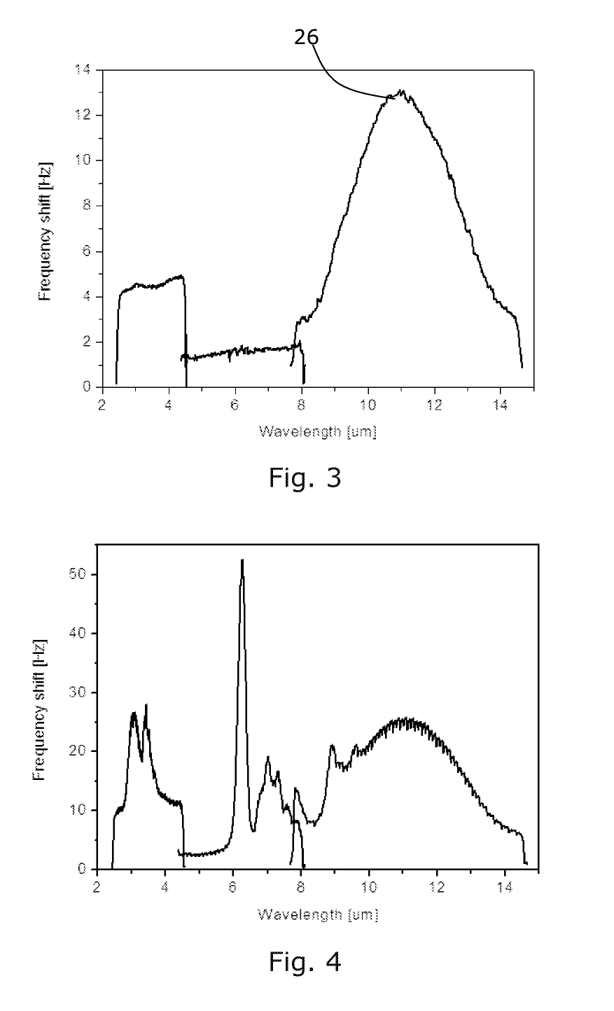

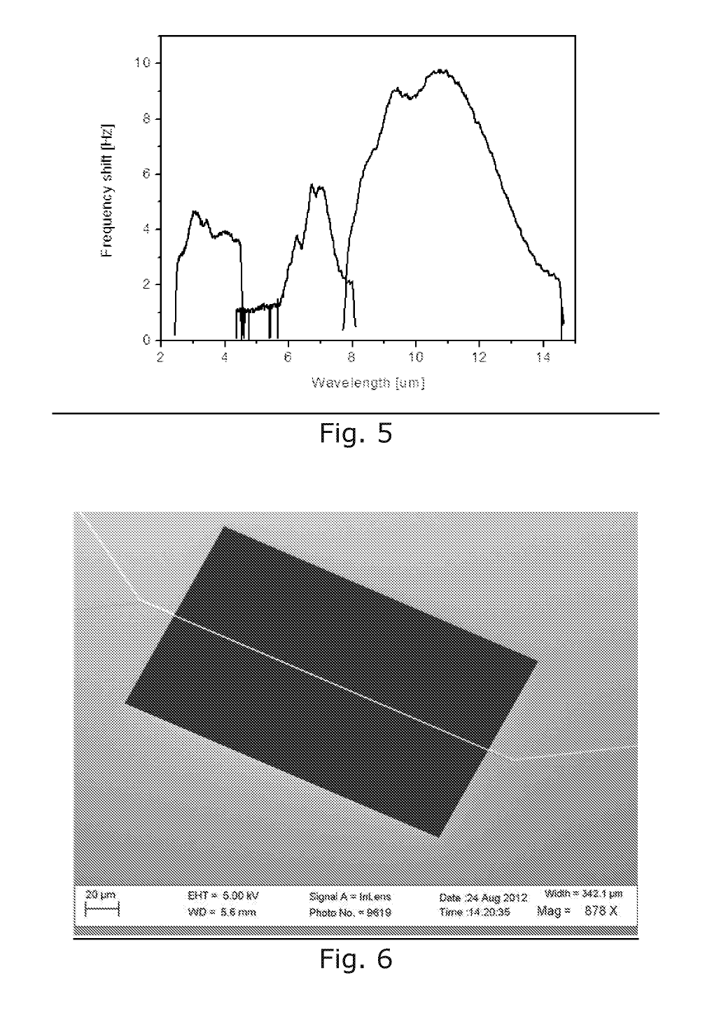

FIG. 3 schematically illustrates the photo thermal resonance spectrum of a silicon nitride string. The figure shows wavelength on the x-axis and frequency shift on the y-axis. The observed peak 26 near 11 um is in good agreement with the spectrum obtained by FTIR as disclosed in e.g. “D. H. B. Wicaksono et al., IEEE SENSORS 2008 Conference”. FIGS. 4 and 5 illustrates the photo thermal resonance spectrum of deposited NaHCO3 and CaCO3 on silicon nitride string respectively.

In the present setup photo thermal signals depends on the thermodynamic and energy transfer properties of the nanoparticles and the string 20. Temperature changes resulting from absorption of infrared energy are dependent on the vibration modes of the nanoparticles as well as the heat capacity and thermal conductivity of the string 20. When irradiated the nanoparticles in the sample are excited into vibration modes by absorption of IR photons and the non-radiative de-excitation of the molecules results in thermal energy. The thermal energy is then transferred to the string causing resonant frequency shift in the string 20. The extent of resonant frequency shift is proportional to the amount of thermal energy transferred to the string.

The relative intensities of the peaks were different for a photo thermal spectrum as compared to a conventional IR spectrum. Also some peaks that are not very prominent in conventional IR spectra appear to have higher intensity in the photo thermal spectra. This may be directly related to the efficiency of non-radiative decay of these excited states. The extent of resonance frequency shift is directly proportional to the deposited material, the impinging power of IR radiation, the absorption mode, and the thermal sensitivity of the string.

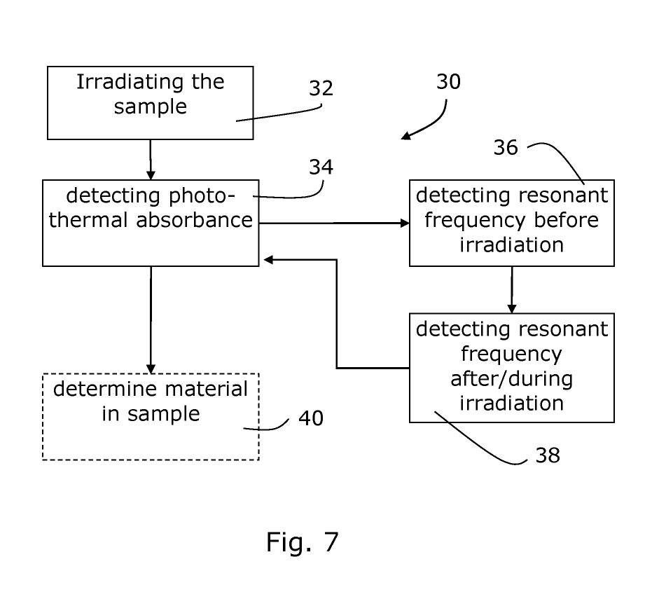

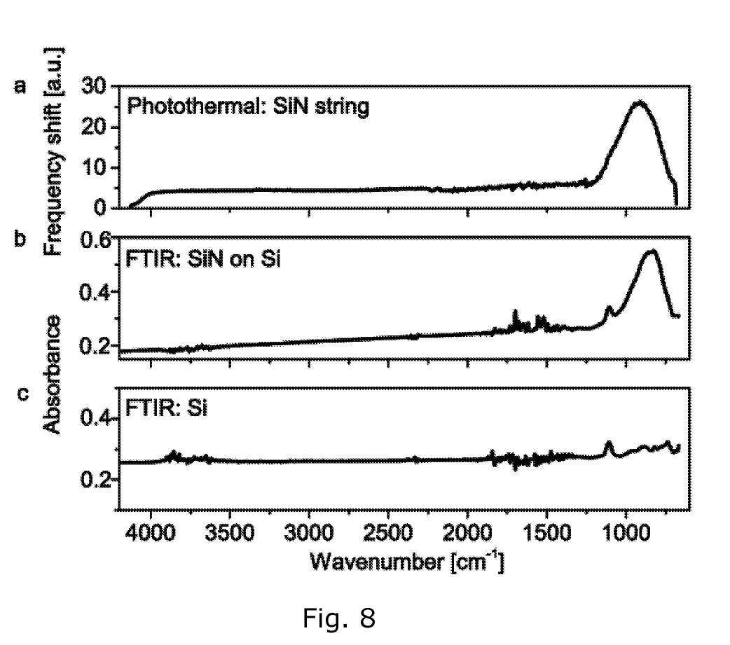

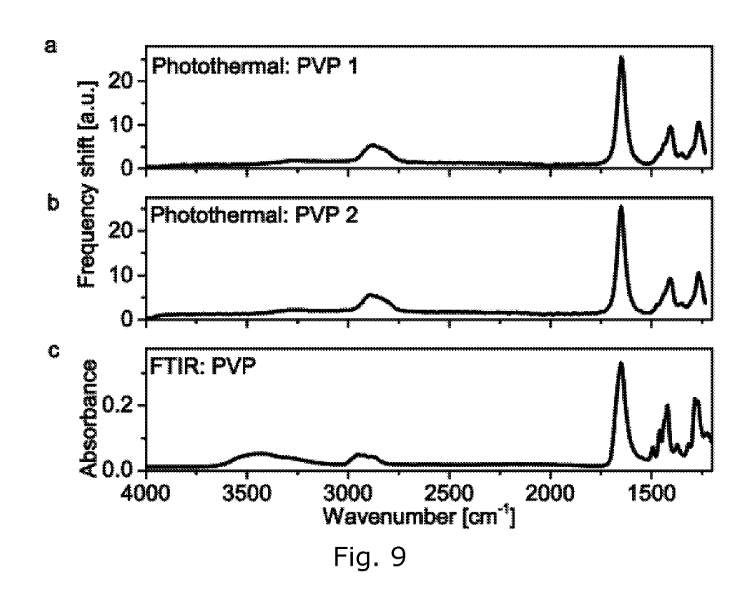

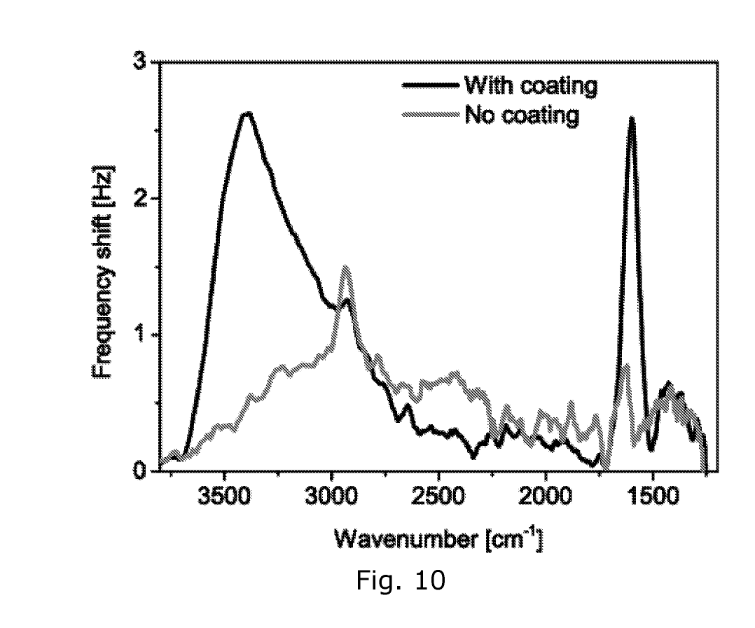

FIG. 7 schematically illustrates steps of a method 30. The method 30 is used for detecting photo-thermal absorbance of a material utilising a mechanically temperature sensitive resonator and a sample being arrange in thermal communication with the temperature sensitive resonator. The sample has a wavelength dependent absorption rate and is deposited on the mechanically temperature sensitive resonator. The mechanically temperature sensitive resonator may e.g. be a microstring 20 as discussed above.

The method 30 comprises a step 32 of irradiating the sample at a pre-selected wavelength. The sample absorbs the radiation at a certain wavelength or wavelengths resulting in a temperature increase of the sample and the temperature sensitive resonator, which in turn changes a resonance frequency of the temperature sensitive resonator. The method 30 comprise a step 34 of detecting photo-thermal absorbance by a change in resonance frequency of the temperature sensitive resonator, wherein the detecting of change in resonance frequency is based on a detection 36 of the resonance frequency of the temperature sensitive resonator prior to irradiation of the sample and a detection 38 of the resonance frequency of the temperature sensitive resonator during and/or after the irradiation of the sample. The method 30 may include a step 40 of determining on the basis of the measurements and photo-thermal absorbance which material was in the sample.

FIG. 8 illustrates an IR spectrum of a bare silicon nitride string measured by photothermal spectroscopy, showing a strong and broad absorption peak at 904 cm-1. This peak position has been verified by means of conventional FTIR spectroscopy. FIGS. 8b and 8c show the IR spectra of a silicon wafer and a silicon wafer with a 185 nm thick silicon nitride layer measured by an FTIR spectrometer. From these two IR spectra it can be deduced that the silicon nitride layer has an absorption peak at 895 cm⁻¹. Silicon nitride is known to have an absorption peak at 830-1250 cm⁻¹, depending on the thickness of the silicon nitride. The absorption peak is shifted to longer wavelengths when the thickness of the silicon nitride is reduced. This absorption is caused by stretching of Si—N bonds and the peak position is in good agreement with the position determined by photothermal IR spectroscopy. FIGS. 8b and 8c also show an absorption peak at 1106 cm⁻¹ deriving from silicon. The absorption peaks at 1400 cm⁻¹-1800 cm⁻¹ and 3600 cm⁻¹-4000 cm⁻¹ derive from water vapour and the absorption peak at 2350 cm⁻¹ derives from carbon dioxide since there samples were measured in air.

Biodegradable polymers are becoming increasingly used and there is a large demand for polymer characterization and identification. PVP was atomized and the resulting aerosol was sampled on a string resonator. In FIGS. 9a and 9b, IR spectra of PVP deposited on two different strings measured by photothermal spectroscopy show the repeatability of the measurement. It can be seen that the two IR spectra of PVP from two different strings measured by photothermal spectroscopy are highly reproducible. All the four major absorption peaks in the IR spectra measured by photothermal spectroscopy at 1267 cm-1, 1407 cm-1, 1651 cm-1 and 2878 cm-1 are in excellent agreement with the reference IR spectrum of PVP measured by an FTIR spectrometer in air, showing major absorption peaks at 1285 cm-1, 1422 cm-1, 1651 cm-1, and 2951 cm-1 (FIG. 3c). The distinct peak at 1651 cm-1 is coming from the carbonyl double bond in PVP. The extra absorption peak at 3428 cm-1 of the FTIR measurement comes from water vapor.

Analysis of airborne nanoparticles is a common scenario in the field of environmental and workplace safety. Chemical identification of airborne nanoparticles typically requires an electron microscope featuring an energy-dispersive X-ray spectrometer and is therefore time consuming and expensive.

The combination of efficient in-situ sampling and photothermal IR spectroscopy is very attractive for chemical analysis of airborne engineered nanoparticles. The often used organic surface coating of engineered nanoparticles has shown to play a major role in the toxicity of nanoparticles. It is therefore highly desired to be able to detect and distinguish surface coatings of nanoparticles. FIG. 10 shows the differential IR spectrum of TiO2 nanoparticles with and without coating measured by photothermal spectroscopy. It can clearly be seen that the spectrum of TiO2 with coating has two extra peaks at 1597 cm-1 and 3389 cm-1. The coating on the TiO2 nanoparticles contains glycerol, tetramethyl silicate, hexadecanoic acid methyl ester and octadecanoic acid methyl ester as major substances. The broad peak at 3389 cm-1 is typical from the stretching vibrations of O—H bonds that are present in the glycerol of the particle coating. The sharp peak at 1597 cm-1 could be coming from the stretching of the double bonds in the two different ester compounds. According to the specifications, the weight of the coating was 2% of the mass of the nanoparticles. This results in a total coating mass of 4 pg for a total TiO2 nanoparticle mass of 200 pg.

For the presented measurements, an IR monochromator with a thermal light source has been used. The power of radiated light absorbed by the micromechanical string resonator is estimated from the measurement of the bare silicon nitride string. The absolute frequency shift of silicon nitride of −13.1 Hz at 904 cm-1 (FIG. 8a) corresponds to a relative frequency shift of 52.5 ppm. The relative resonance frequency change of a mechanical string resonator (with length L and cross section area A) as a function of the absorbed power P in the string center is given by

$$\frac{Δ f}{f} = - \frac{α E}{{σ}_{0} κ} \frac{L}{16 A} P$$

with Young's modulus E, thermal expansion coefficient α, tensile pre-stress σ0, and thermal conductivity κ, of the string material. From the above equation, it is calculated that the measured frequency shift corresponds to approximately 2.7 nW of absorbed heat in the string. The absorbance of silicon nitride can be extracted from the FTIR measurements by subtracting the absorbance of bare silicon (FIG. 2c) from the absorbance of silicon nitride on a silicon wafer (FIG. 8b).

A differential absorbance of 0.196 can be calculated at 904 cm-1, which results in an IR power radiated on the string of approximately 14 nW. The calculations were done assuming the following parameters: Tensile stress 200 MPa, mass density 3100 kg/m3, thermal coefficient of expansion 1.23 ppm/K, Young's modulus 250 GPa, and thermal conductivity 2.5 W/(m K).

A noise value is required to estimate the detection limit of the sensor. The noise comes mainly from temperature drift in the chamber and power fluctuation in the readout laser. We have calculated the Allan deviations of frequency vs. time measurements for three scenarios using an uncoated string: i) without IR light, ii) with IR light at 1176 cm⁻¹ where there is low absorption in silicon nitride, and iii) with IR light at 909 cm⁻¹ where there is high absorption in silicon nitride. Allan deviations of a (1 s)≈1.2×10⁻⁷, a(1 s)≈1.1×10⁻⁷, and a(1 s)≈1.3×10⁻⁷ were obtained from the respective measurements. It can be seen that IR radiation does not change the Allan deviation. From the Allan deviation a(1 s)≈1.1×10⁻⁷ and the relative frequency change 20786 W⁻¹, the detection limit is calculated to be approximately 16 pW for a signal to noise ratio of 3. This is similar to that of more complex bimaterial cantilevers with a typical detection limit of 12 pW for the same signal to noise ratio.

The minimum detectable sample mass can be estimated from the maximum induced frequency shift of ˜2.6 Hz (see FIG. 10) for a mass of 4 pg. This relates to a relative frequency change of roughly 2.5×106 g⁻¹, which results in a minimum detectable mass of 44 fg with an Allan deviation of 1.1×10⁻⁷. Considering the linear relationship of photothermally induced frequency detuning and radiated light power, the estimated femtogram-scale mass resolution for nW-scale radiation power is well in agreement with the attogram-scale resolution obtained with similar mechanical resonators irradiated with a visible μW-laser. The sensitivity of the presented photothermal IR spectroscopy can be improved by several orders of magnitude by replacing the weak thermal IR source and monochromator with a more powerful light source. Modern tunable quantum cascade lasers provide IR powers of up to several 100 mW which could enable measurements at atmospheric pressure in the future. Additionally, the sensitivity can be enhanced by optimizing the string design according to the analytical model e.g. longer strings with smaller cross-section area. The combination of an optimized string design and stronger radiation power gives prospect to photothermal IR spectroscopy in the zeptogram-range.

The invention can be implemented by means of hardware, software, firmware or any combination of these. The invention or some of the features thereof can also be implemented as software running on one or more data processors and/or digital signal processors.

The individual elements of an embodiment of the invention may be physically, functionally and logically implemented in any suitable way such as in a single unit, in a plurality of units or as part of separate functional units. The invention may be implemented in a single unit, or be both physically and functionally distributed between different units and processors.

Although the present invention has been described in connection with the specified embodiments, it should not be construed as being in any way limited to the presented examples. The scope of the present invention is to be interpreted in the light of the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A method for detecting photo-thermal absorbance of a material utilising a micro- or nanostring as a mechanically temperature sensitive resonator and a sample being arrange in thermal communication with the temperature sensitive resonator, the sample having a wavelength dependent absorption rate, the method comprising:
irradiating the sample at a pre-selected wavelength,
the sample absorbing the radiation at a certain wavelength or wavelengths resulting in a temperature increase of the sample and the temperature sensitive resonator, which in turn changes a resonance frequency of the temperature sensitive resonator,
detecting photo-thermal absorbance by detecting a change in resonance frequency of the temperature sensitive resonator, wherein
said detecting of change in resonance frequency is based on a detection of the resonance frequency of the temperature sensitive resonator prior to irradiation of the sample and a detection of the resonance frequency of the temperature sensitive resonator during and/or after the irradiation of the sample.

2-14. (canceled)

15. The method according to claim 1, wherein the step of irradiating the sample comprises irradiating the sample while changing the pre-selected wavelength according to a pre-selected scheme.

16. The method according to claim 15, wherein the pre-selected scheme includes sweeping the wavelength over a wavelength interval.

17. The method according to claim 1, further comprising applying a vibration at a predefined frequency to the temperature sensitive resonator.

18. The method according to claim 1, wherein the length of the resonator is in the interval of 100 nm to 10 mm, in the interval of 1 um to 10 mm, in the interval of 150 to 300 um, or is 213 um, and/or the thickness of the resonator is in the interval of 1 nm to 100 um, or is 185 nm, and/or wherein the width of the resonator is in the interval of 1 nm to 1 mm, or is 1.2 um.

19. The method according to claim 1, comprising an initial step of depositing an amount of material on the sample.

20. The method according to claim 1, wherein the step of detecting a change in resonance frequency of the resonator is performed using a vibrometer.

21. The method according to claim 1, further comprising determining a characteristic of the sample by the detection of the shift in resonance frequency.

22. The method according to claim 1, wherein the change in resonant frequency is more than 1% of the initial resonance frequency.

23. The method according to claim 1, further comprising providing a temperature regulator and, wherein the method comprises maintaining a constant temperature.

24. An apparatus for detecting photo-thermal absorbance of a sample, the apparatus comprising:
a micro- or nanostring configured to be a mechanical temperature sensible resonator having a sample-area to receive a sample, the apparatus comprising:
a light source for irradiating light at a pre-selected wavelength at least onto the sample-area of the resonator, in case a sample is present at the sample-area the sample absorbs an amount of the irradiated light,
a photo-thermal absorbance detection device arranged for determining resonance frequency of the mechanical temperature sensible resonator, and
a material determination device in communication with the photo-thermal absorbance detection device being configured for determining a change in resonant frequency of the mechanical temperature sensible resonator after a deposition of a sample on the sample-area, wherein the determination of change in resonance frequency is based on a detection of the resonance frequency of the resonator prior to heating and a detection of the resonance frequency of the resonator during and/or after the heating.

25. The apparatus according to claim 24, further comprising a resonator device connected to the mechanical temperature sensible resonator so as to induce a vibration in the mechanical temperature sensible resonator.

26. The apparatus according to claim 24, further comprising a temperature regulating device for maintaining a constant ambient temperature at the mechanical temperature sensible resonator.

27. The apparatus according to claim 24, wherein the photo-thermal absorbance detection device is a vibrometer.
